(19) United States
(12) Patent Application Publication
(10) Pub. No.: US 2003/0136352 A1
(43) Pub. Date: Jul. 24, 2003

(54) Cat toy and method

(76) Inventors: Erik C. Lazarich, Saint Paul, MN (US); William J. Lazarich, Saint Paul, MN (US)

Correspondence Address: James V. Harmon, 1000 Northstar Center East, 608 Second Avenue South, Minneapolis, MN, 55402, US

(21) Appl. No.: 10/051,710

(22) Filed: Jan. 22, 2002

(51) Int. Cl. A01K 29/00

(52) U.S. Cl. 119/708

(57) ABSTRACT

A cat toy that encourages a cat to play even if the cat is shy or hiding has a handle to be held by a person using the toy with a flexible line, cord or string connected at one end to the handle and at the other end to a plaything such as a feather or ribbon. Also connected to the handle is a sound producing device such as a bell, chime, or rattle that can be used by a person to produce a characteristic sound that will, over a period of time, become to be recognized by the cat whenever the toy is to be used to produce a reaction showing the cat is eager to play. The sound producing device can be a bell connected to the free end of the handle so that the bell will ring whenever the handle is moved up and down or from side to side in synchronization with the movement of the plaything.

### FIELD OF THE INVENTION

This invention relates to animal training and entertaining more particularly to a toy for animals and to a method of encouraging a cat to play.

### BACKGROUND OF THE INVENTION

Cats are often shy, timid or fearful and will sometimes hide under a chair or a bed when the owner wants to get their attention or play with them. If people come to visit, a cat will often slink away and hide. While a number of toys have been developed for encouraging cats to play, they are frequently unable to gain the attention of the cat if the cat is hiding or is timid. U.S. Pat. No. 4,499,855 for example, provides a toy consisting of an object connected to the string but there is no effective way of encouraging the cat to come forward if the cat is hiding. Accordingly, it is an important object to the present invention to provide a cat toy that is effective in encouraging the cat to play even if the cat is timid or fearful or is hiding under a bed or is otherwise out of sight. Another object is to provide a cat toy which is entertaining for the cat and its owner, encourages the cat to play, is rugged in construction and can be produced at a low cost. A more specific object of the invention is to provide a cat toy which will, through repeated use over a period of time, cause the cat to react in a way that shows it is ready to play as soon as the user picks up the toy even if the cat is timid or is hiding.

These and other more detailed and specific objects of the present invention will be better understood by reference to the following figures and detailed description which illustrate by way of example but a few of the various forms of the invention within the scope of the appended claims.

### THE FIGURES

FIG. 1 is a perspective view of the invention during use.

FIG. 2 is a perspective view of the top portion of the toy on a larger scale than in FIG. 1.

FIG. 3 is an enlarged view showing how a plaything is connected to the end of a cord.

### SUMMARY OF THE INVENTION

This invention provides a cat toy and method designed to encourage a cat to play even if the cat is shy or is hiding. It includes a handle to be held in the hand. A flexible line, cord or string is connected at one end to the handle and at the other end to a plaything such as a feather or ribbon. Also connected to the handle is a sound producing device such as a bell, chime, or rattle that can be used by a person to create a characteristic sound each time the toy is used so that the sound will be recognized by the cat whenever the toy is played with. In its preferred form the sound-producing device is a bell connected to the free end of the handle so that the bell will ring when the handle is moved up and down or from side to side in synchronization with the toy.

### DETAILED DESCRIPTION OF THE INVENTION

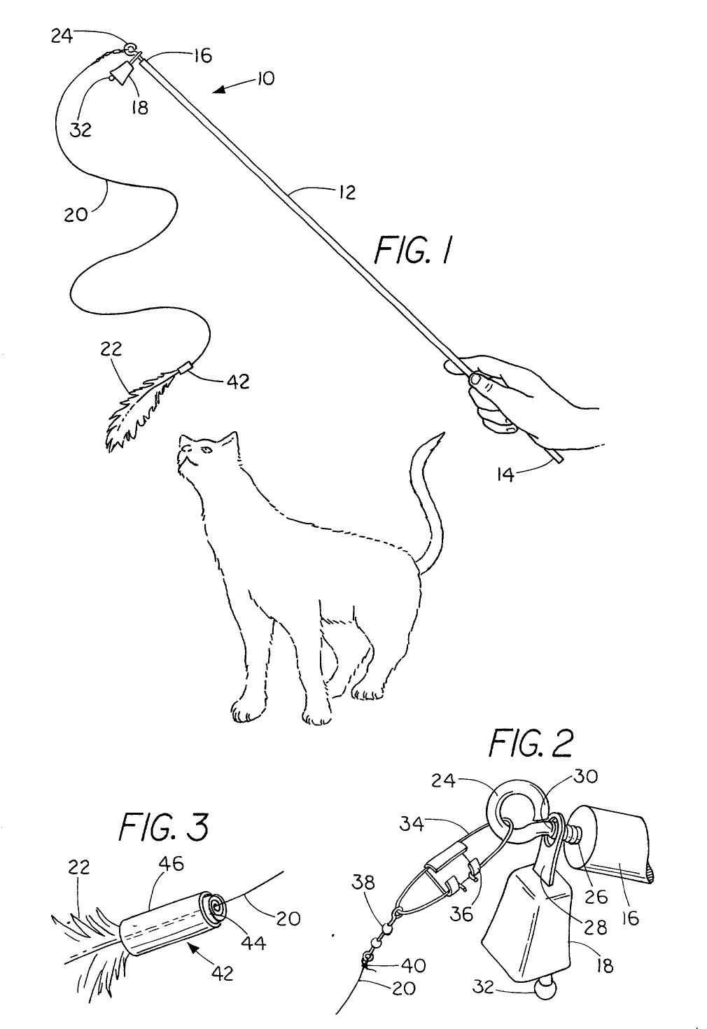

Shown in FIG. 1 is a cat toy indicated generally by the numeral 10. It includes a handle 12 that can be conveniently formed from a ¼ inch wooden dowel about 2 or 3 feet in length. One end 14 of the handle can be held in the hand and the opposite end is provided with a fastener 24 such as an eye hook to which is connected a flexible line 20 such as a cord, string or lanyard or other flexible line e.g., monofilament fishing line of 20 pound test or a multi-strand fishing line. Connected to the lower end of the line 20 is a plaything 22 such as a feather, ribbon, artificial mouse, tinsel, etc. A feather is highly preferred because it can be made to dart, drift and float in various directions. Connected loosely to the free end 16 of the handle 12 is a sound producing device that produces sound mechanically when moved such as a bell 18 or other like device e.g., a chime or rattle. In the embodiment shown, the bell 18 includes an upwardly extending flange 28 with an opening 30 that is substantially larger than the diameter of the eye hook 24 so that the bell 18 dangles loosely at the upper end 16 of the handle 12. Inside the bell 18 is a clapper 32. The handle is fairly stiff to achieve the best motion of the feather 22.

The line 20 is preferably connected to the eye hook 24 by means of a quick disconnect clasp 34 of any suitable, commercially available type, for example, one that includes a U-shaped wire spring 36 which can be disengaged 36 by applying finger pressure to allow the line 20 to be disconnected so that a different plaything 22 can be attached. The line 20 is tied at 40 to a swivel 38 which is itself fastened to the connector 34.

Refer now to FIG. 3 which shows how the feather 22 is connected to the line 20. It can be seen that the upper end of the feather (the end that is connected to the line 20) is weighted by means of a weight 42 which can be a fraction of an ounce. The feather 22 includes a quill, only a part of which is shown, that extends into the center of the weight 42 and is tied to the line 20. To make the weight, a strip of electrician's tape 44 is wound around the quill. The tape is then enclosed in a short piece of heat-shrink tubing which is shrunk into place by applying heat to the tubing. The weighted connection 42 adds interest to the motion of the plaything 22 by helping it to dart, glide or float through the air and to fall quickly when tension on the line 20 is released.

The manner in which the toy is used will now be described. Much of the advantage of the invention derives from the well-known fact that cats are often timid or even fearful when people enter a room and even if that is not the case they sleep for many hours of the day under furniture, etc., or are otherwise out of sight. In the course of developing the present invention, various toys were tried but they were often found to be ineffective in encouraging the cat to play. It then became clear that it would be desirable to find a way of providing a toy that would cause the cat, over a period of time, to recognize it was time to play, to know that the toy would be available and to be eager to play. To accomplish this the sound producing device 18 is provided where it can be manipulated manually by being attached to the handle 12 so that a special sound is produced each time the toy is used. Over a period of repeated use, the sound, synchronized with movement of the plaything 22, will gradually cause the cat to acquire a positive reaction to the bell that clearly indicates that it is eager to play and will cause even a shy or fearful cat to come forward or even to burst into view from under a bed or chair where it was hiding or sleeping. This behavior becomes reinforced each time the toy is used. It is important that the same bell, chime, rattle, or other sound producing device 18 be used consistently so that when the handle 12 is moved up and down or side to side the characteristic sound will then be recognized by the cat as the one associated with the movement of the plaything 22.

### RESULTS

The toy as described herein was tried with several cats, some of which were often fairly timid, with excellent results. All of the cats invariably became highly motivated to play with the toy even if sleeping or under the furniture. After a learning period, the cat would often jump out to play with the toy as soon as the bell was rung.

Usually the cat will come running eagerly to play on hearing the sound even if it has been sleeping under a bed or is otherwise out of sight. It takes a few days for the cat to acquire the desired reaction which shows it is eager to play. However, once acquired the cat will come running and will be eager to play as soon as the sound of the bell 18 is heard.

While any kind of a sound producing device can be used, a mechanical sound producer is preferred i.e., one which produces a sound in response to movement of the handle 12 and plaything 22 rather than an electrical or electronic sound producing device which is much more expensive to produce and is not as easily coordinated with the movement of the handle and plaything.

Many variations of the present invention within the scope of the appended claims will be apparent to those skilled in the art once the principles described herein are understood.

What is claimed is

1. A cat toy for encouraging a cat to play even if fearful or timid comprising, a handle, a flexible line connected at one end to the handle, a plaything connected to the other end of the line, a sound producing device connected to the cat toy for providing a characteristic sound when the handle is moved for developing an acquired reaction on the part of the cat through repeated use whereby the cat eventually recognizes the characteristic sound and responds thereto by showing it is eager to play with the plaything when it hears the sound.

2. The cat toy of claim 1 wherein the sound producing device comprises a bell, chime, rattle or other mechanical sound producing device connected to the handle for producing a sound responsive to the movement thereof.

3. The cat toy of claim 1 wherein the handle comprises an elongated rod, a fastener is secured to the end of the rod handle, the sound producing device comprises a bell supported by the fastener and one end of the line is secured to the fastener.

4. The cat toy of claim 3 wherein the fastener is an eyehook and a releasable clasp is secured between the eyehook and the line for enabling the line and plaything to be removed and replaced when desired.

5. The cat toy of claim 1 wherein the plaything comprises a flexible article and a weight is secured to one end thereof for enhancing the movement of the plaything.

6. The cat toy of claim 5 wherein the plaything is a feather and the weight is secured to an end of the feather connected to the line.

7. The cat toy of claim 6 wherein the feather includes a quill portion which is connected to the line and the weight surrounds the connections between the quill and the line for enhancing the movement of the feather.

8. A cat toy for encouraging a timid or fearful cat to play comprising, a handle, a flexible line connected at one end to the handle, a plaything connected to the other end of the line, a sound producing device that comprises a bell, chime, rattle, or other mechanical sound producing device connected to the cat toy for providing a characteristic sound when the handle is moved to develop an acquired reaction on the part of the cat through repeated use whereby the cat eventually recognizes the characteristic sound and responds thereto by showing it is eager to play with the plaything when it hears the sound and the sound producing device is mounted on the handle such that movement imparted to the handle by a person holding an end thereof is able to produce sounds synchronized with movement of the plaything.

9. The cat toy of claim 8 wherein the plaything comprises a flexible article and a weight is secured to one end thereof for enhancing the movement of the plaything.

10. The cat toy of claim 8 wherein the plaything is a feather and a weight is secured to an end of the feather that is connected to the line for enhancing the motion of the feather.

11. The cat toy of claim 8 wherein the plaything is a feather, includes a quill portion which is connected to the line and a weight surrounds the connections between the quill and the line for enhancing the movement of the feather.

12. A method of encouraging a cat to play comprising,
providing a cat toy having a handle, a flexible line connected at one end to the handle and at the other end to a plaything and a sound producing device is connected to the cat toy for providing a characteristic sound when the handle is moved,
grasping the handle and moving the handle so as to cause the sound-producing device to make a characteristic sound as motion is imparted to the plaything from the handle through the line,
such that the cat eventually recognizes the characteristic sound and responds thereto by showing it is eager to play with the plaything when it hears the sound.

13. The method of claim 12 wherein the toy is used repeatedly over time until the cat learns to respond to the sound by showing it is eager to play upon hearing the sound.

14. The method of claim 12 including the step of providing a bell attached to the handle and ringing the bell in synchronization with movement of the plaything by moving the handle.

15. The toy of claim 1 wherein the plaything is releasably connected to the handle by means of a clasp that can be opened manually.

16. A cat toy comprising, a plaything connected to a flexible line, said line being adapted to be moved by a person to impart motion to the plaything and a noise producing device operatively connected to the toy and under the control of the person for producing a sound when the device is moved by the person, whereby the cat eventually recognizes the characteristic sound produced by the device so as to respond upon hearing the sound by playing with the plaything.

17. The cat toy of claim 16 wherein the sound producing device comprises a bell, chime, rattle or other mechanical sound producing device connected to a handle for producing a sound responsive to the movement thereof.

18. The cat toy of claim 16 wherein the plaything comprises a flexible article and a weight is secured to one end thereof for enhancing the movement of the plaything.

19. The cat toy of claim 16 wherein the plaything is a feather and a weight is secured to an end of the feather connected to the line.
